(19) United States
(12) Patent Application Publication
(10) Pub. No.: US 2010/0018198 A1
(43) Pub. Date: Jan. 28, 2010

(54) VALVE ARRANGEMENT

(76) Inventor: Winfried Rüb, Waldshut-Tiengen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/449,929

(22) PCT Filed: Jan. 18, 2008
(86) PCT No.: PCT/EP2008/000362

§ 371 Date: Sep. 3, 2009

(30) Foreign Application Priority Data
Mar. 27, 2007 (DE) 10 2007 014 550.2

(51) Int. Cl. F15B 11/05; F15B 11/16; F15B 13/06

(52) U.S. Cl. 60/422; 60/426; 137/596.13; 91/446

(57) ABSTRACT

The invention relates to a valve arrangement having an adjustable control valve (10), comprising a control slide (12) for actuating at least one consumer connection (A,B), and having an LS control line, wherein the differential pressure of two actuating pressures (Xₐ, X_{b}) serves for the actuation of the control slide (12). Due to the fact that the actuating pressures (Xₐ, X_{b}) also actuate a logic valve, which in turn influences an additional valve, and/or actuates a pressure scale that is connected upstream to the control valve (10) having the control slide (12), the difference of the two actuating pressures (Xₐ, X_{b}) initially displaces the control slide of the control valve, wherein the higher or the lower of the two actuating pressures (Xₐ, X_{b}) either actuate the further valve in the form of the additional valve, and/or influences the pressure scale.

The invention relates to a valve arrangement with an adjustable directional control valve with a control slide for actuating at least one consumer connection and with an LS control line, the pressure difference of the two actuating pressures xₐ, x_{b} being used to actuate the control slide.

Valve arrangements of the indicated type are being increasingly designed as valve modules which make it possible to acquire a certain number of special alternative embodiments in addition to implementation of standard alternative embodiments. Generally these special alternative embodiments increase not only the construction effort for the alternative embodiment itself, but also the installation space which is be kept available therefor within the standard valve module.

One typical case for electrically controlled valves is the desire of the user to be able to execute a pressure switching function or independent switching function, besides controlling the directional control valve. For example, the function of “quantitative cutoff” is desired in which by pressure limitation in the piloting of a section compensator the control cross section of the compensator in the inflow to the slide diaphragm of the directional control valve is closed. Currently solutions are possible in which these valves are offered with setscrews by means of which the maximum inflow pressure to the two consumer connections (pipe connection) A or B or A and B can be set. The setscrews are generally adjusted by hand; this is accompanied by interruptions in operation on the machine.

Electrical adjustment by setting a potentiometer would thus be a desirable improvement, in this respect in the prior art, lines of mobile directional control valves being known which for implementation of such an electrical adjustment function, however, require a third proportional magnet which in turn takes up much installation space on the pertinent machine. Furthermore, there are additional wiring costs for implementation of the required bus hardware.

EP 0 935 713 B1 discloses a valve arrangement for actuating a consumer with a directional control valve which is continuously adjustable and which acts as an inflow throttle, via which a pump connection can be connected to the consumer connections A, B, the respective consumer being connected to the directional control valve via working lines and in each working line there being a throttle means via which the volumetric discharge flow of hydraulic oil can be set by the consumer. In that in the known solution one control side of the throttle means and one control side of the directional control valve at a time are each connected to one control unit at a time by way of a control channel, by means of two control units the control pressures in the two control channels being adjustable independently of one another, such that when the inlet volumetric flow is set the two control pressures are greater than zero and the discharge-side throttle means can be completely opened independently of the valve slide position of the directional control valve, a valve arrangement is devised in which with minimized hardware cost the energy losses can be minimized in the discharge from a consumer. The hydraulic volumetric flow is set by way of the directional control valve which acts as an inflow throttle.

The throttle means in the known solution also has two return throttles which are each assigned to a consumer connection A or B. Each of these return throttles is provided with a tank connection T and there is a permanent connection between the return throttles and the actuating pressures xₐ, x_{b} which can be assigned each time and which in this respect acts as an actuating pressure in the opposite direction on the control slide with the inflow diaphragm of the directional control valve. This directional control valve does not have a tank connection T in this regard. Thus, for the known solution, in addition to the control slide of the directional control valve, the respective return throttle is controlled by way of a total of two proportional magnets which are independent of one another and which make available the indicated control pressures xₐ, x_{b}. This known valve arrangement combined into a valve block is in turn relatively large.

DE 10 2005 050 169 A1 discloses an LS control arrangement with a directional control valve via whose valve slide, when set in one direction, a first consumer connection A and, when set in the other direction, a second consumer connection B can be connected to one inflow connection P and the respectively other consumer connection can be connected to a discharge connection T, by way of the inflow control edge the opening cross section of an inflow metering orifice being determined which in turn is assigned an individual compensator for keeping the pressure drop constant over the inflow metering orifice, and with an LS control oil flow path via which the load pressure can be tapped downstream from the inflow metering orifice and can be reported through the valve slide into the LS control chamber of the directional control valve, a maximum pressure in the LS control oil flow path being limitable by way of a pressure limitation valve. In that in the known solution the LS control oil flow path during setting of the valve slide in one direction in succession or overlapping can be connected to two pressure limitation chambers to which one pressure limitation valve at a time can be assigned for LS pressure limitation, multistage inflow pressure limitation is possible and the load pressure can be limited to different values in different stroke ranges of the valve slide; this is advantageous for certain tasks in mobile machinery. Continuous adjustment processes are, however, not possible with the known solution.

Proceeding from this prior art, the object of the invention therefore is to further improve the known solutions such that continuous adjustment of the valve arrangement is possible and that it requires little installation space. This object is achieved by a valve arrangement with the features of claim 1 in its entirety.

In that, as specified in the characterizing part of claim 1, the actuating pressures xₐ, x_{b} additionally actuate a logic valve which in turn acts on an additional valve and/or actuates a compensator which is connected upstream from the directional control valve to the control slide, the difference of the two actuating pressures xₐ, x_{b} first closes the control slide of the directional control valve, the higher or the lower of the two actuating pressures xₐ, x_{b} either actuating the other valve in the form of the additional valve and/or acting on the compensator. The two proportional magnets which are intended preferably for making available the actuating pressures xₐ, x_{b} are operated at the same time, the choice of the higher or lower pilot pressure as the actuating pressure xₐ, x_{b} taking place by a logic valve which is designed preferably as a selector valve or inverted selector valve.

In one preferred embodiment of the valve arrangement according to the invention, the additional valve is a pressure limitation valve DBV, in particular an LS-DBV in the valve section. Since actuating a high pressure limitation valve takes place with low pressure, preferably a pressure intensification stage is interposed. The other valve or additional valve can also be designed as a corresponding check valve RV. Again pressure intensification is necessary for unblocking of this high pressure RV.

In order to be able to equalize valve tolerances which arise due to the sequence of control edges on the directional slide and the interplay with the opening point of the check valve RV, preferably it can be provided that a counterpressure (xₐ, x_{b}) be used to calibrate the opening point of a directional control valve axle to the RV. Possible calibration values can be stored by way of integrated valve electronics. In this case there is no choice between the higher or the lower pilot pressure since the respectively pilot-operated check valve RV is assigned to only one pilot pressure at a time so that in this respect the RV assumes the function of the logic valve.

With the solution according to the invention installation space can be saved and with only a few reliable components so-called “quantitative cutoff” can be electrically undertaken and adjusted. Another possible application consists in so-called support pressure control in which the support force of an implement can be reduced; this applies, for example, in the reciprocating finger bar movers of slope mowers, reel guides of combine harvesters and so-called packers on tractors, etc.

Other advantageous embodiments are the subject matter of the other dependent claims.

The valve arrangement according to the invention is detailed below using different embodiments as shown in the drawings. The figures are schematic in the form of diagrams.

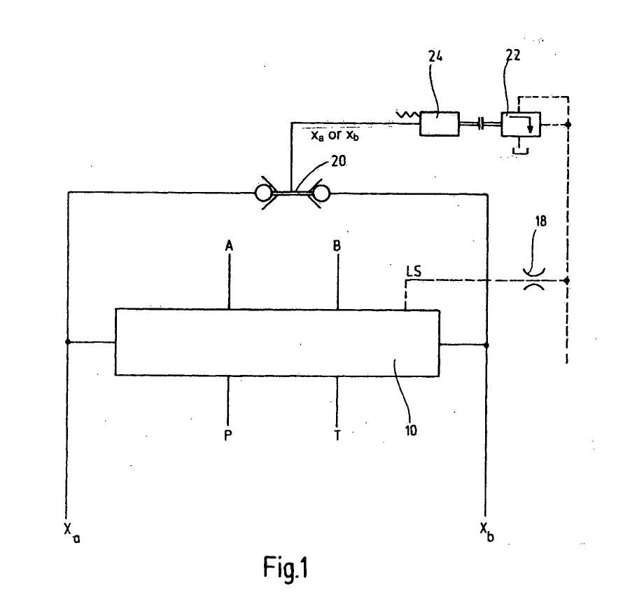

FIGS. 1 to 4 shows four embodiments of the valve arrangement according to the invention which are different from one another, FIG. 1 relating to the basic structure of the valve arrangement.

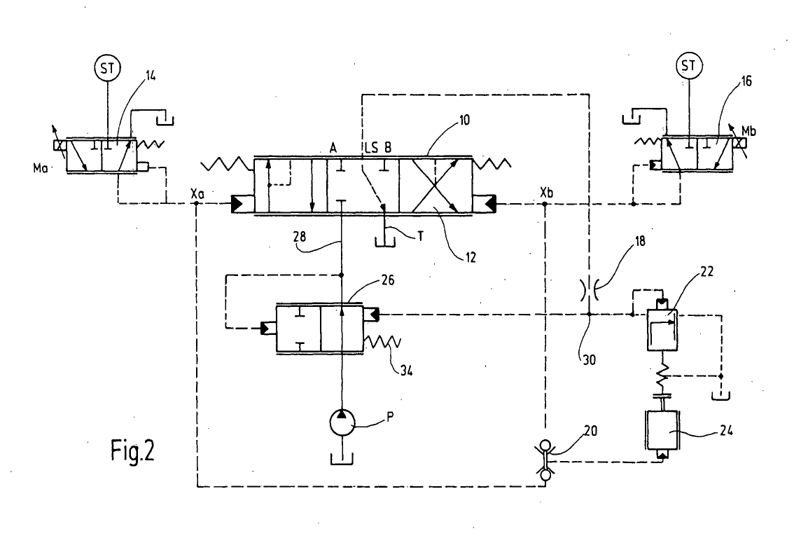

Thus FIG. 1 shows a valve arrangement with an adjustable directional control valve 10 with a control slide 12 (FIG. 2 et seq.) for actuating two consumer connections A, B. The structure of these adjustable directional control valves 10 with the control slide 12 has been sufficiently known in the prior art (EP 0 935 713 B1, DE 10 2005 050 169 A1) so that they will no longer be detailed here. The directional control valve 10 is furthermore connected to a pressure supply source P, for example in the form of a constant pressure pump which takes from a reservoir, for example in the form of a tank, a hydraulic medium which flows by way of a tank connection T after passing through the hydraulic circuit back into the indicated reservoir. In these embodiments of the valve arrangement according to the invention, there is among other things the particularity that the directional control valve 10 has the pertinent tank connection T.

Furthermore, the directional control valve 10 has an LS control line which is shown in the figures by LS. To actuate the control slide 12 there is a pressure difference of the two actuating pressures xₐ, x_{b} which are conventionally dictated by way of two pilot valves 14, 16 in a manner which is not detailed. The pilot valves 14, 16 are shown in FIGS. 2 et seq., the connection ST referring to the control pressure (conventionally 20 to 40 bar) in the control oil circuit which is used in particular to supply low pressure consumers which are not detailed. Furthermore, the LS control line as shown in FIGS. 1 to 3 is provided with a throttle or diaphragm 18.

As FIG. 1 furthermore shows, the two actuating pressures xₐ, x_{b} act not only in the opposite direction on the control slide 12 of the directional control valve 10, but are also connected in the opposite acting direction to a logic valve 20 which is preferably designed as a selector valve and according to these details is designed especially preferably as a selector valve which acts in an inverted manner. The actuating pressure xₐ acting on the control slide 12 enables a fluid-guiding connection between the connections P and A and the actuating pressure x_{b} acts on the control slide 12 in the opening direction of the connections P and B which are to be connected to one another. If an actuating pressure xₐ, x_{b} is not acting or the actuating pressures xₐ, x_{b} are mutually cancelled in terms of their differential pressure, the control slide 12 assumes its spring-centered middle position as is shown in FIG. 2 et seq., which is also referred to as the neutral position of the directional control valve 10.

Another valve in the form of an additional valve 22 is connected to the logic valve 22 and is designed as a pressure limitation valve DBV. A pressure intensification stage 24 is connected upstream from the pressure limitation valve DBV on the input side and makes it possible to bring the input pressure from the output side of the logic valve 20 to a higher pressure relative to the input side of the additional valve 22. In this way, it is possible for obtaining improved efficiency of actuation to use the low pilot pressure xₐ or x_{b} to actuate the additional valve 22.

With the basic setup as shown in FIG. 1 it is fundamentally possible to carry out the initially described “quantitative cutoff” in a continuous manner and/or to achieve appropriate support pressure control for an implement, connected to user or consumer connections A, B. But advantageously it is provided that, in addition to the logic valve 20 and the additional valve 22 as shown in FIG. 2, a compensator 26 be connected on the pump input side of the directional control valve 10 between the pressure supply source P and the pertinent input of the directional control valve 10 and the compensator be connected on its one control input side to the pertinent supply line 28 and on the oppositely acting control input side it is connected to a nodal point 30 into which the LS control line discharges, as well as a fluid connection for the additional valve 22 in the form of a pressure limitation valve with connected pressure intensification stage 24. According to the diagram in FIG. 2, with this valve arrangement an electrically actuatable “quantitative cutoff” with two simultaneously operated proportional pilot valves 14, 16 is achieved.

In this embodiment the additional valve 22 is designed as a so-called LS pressure limitation valve (LS-DBV) and is supplied by the LS pressure of the LS control line and in this respect actuates, as indicated, the section compensator 26 which is connected upstream from the control slide 12 of the directional control valve 10. The LS-DBV is actuated by the lower of the two actuating pressures xₐ, x_{b} on its spring side, in turn the selection of the actuating pressures xₐ, x_{b} taking place by the inverted selector valve as a logic valve 20. Since conventionally the control slide 12 is deflected with a lower actuating pressure xₐ, x_{b}, this low pressure must also control the high pressure LS-DBV as an additional valve 22. A pressure intensification stage 24 is used for this purpose; it is connected between the actuating pressure and the so-called spring chamber of the LS-DBV, the pressure boosting piston (not shown) being designed such that with its large surface it adjoins the actuating pressure and the small surface adjoins the spring chamber of the LS-DBV. With this design electrically adjustable quantitative cutoff is advantageously possible.

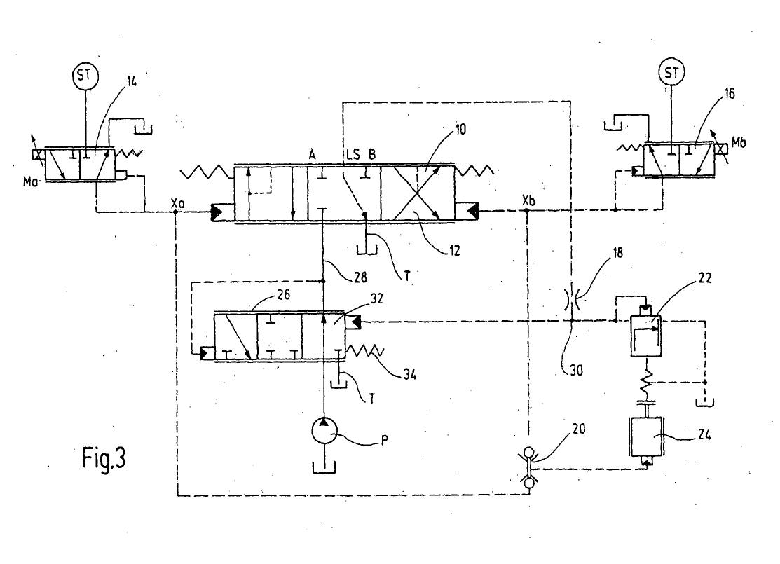

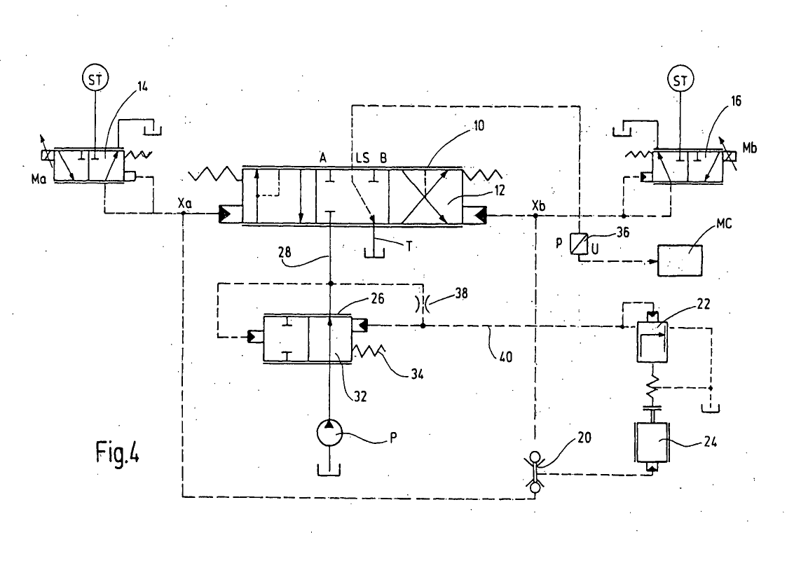

The following exemplary embodiments are explained only to the extent that they differ significantly from the preceding embodiments. The same reference numbers are used for the same components of the valve arrangement and the details to date also apply in this respect to the embodiments as shown in FIGS. 3 and 4 which are still to be presented.

For support pressure control the valve arrangement as shown in FIG. 3 for the section compensator 26 has a tank connection T. This T connection of the compensator 26 can only be opened when the compensator piston 32 in movement against the control spring 34 has first almost completely closed the supply channel P (supply line 28) or is just closing it or has already closed it. Thus not only can pressure limitation in the inflow to the respective pipe connection (consumer connection A, B) be achieved, but also pressure control. The support force of a device of a machine which is not detailed on the ground can be reduced by the section compensator 26 on the one hand being able to control a volumetric flow to the respective consumer connection A, B, but also from the respective consumer connection A, B to the tank connection T with the control slide 12 opened. With the embodiment as shown in FIG. 3 electrically actuatable quantitative cutoff with support pressure control is thus possible.

In the embodiment as shown in FIG. 4 the nodal point 30 with the throttle diaphragm or fixed diaphragm 18 is omitted and the LS control line is connected by way of a pressure sensor 36 to a microprocessor or microcontroller MC of the valve electronics which are not detailed. But the control input sides of the compensator 26 are connected to the supply line 28, in one of the supply lines an additional diaphragm or throttle 38 being used. The indicated control line discharges by way of this throttle 29 into the connecting line 40 between the additional valve 22 and the actuating side of the compensator 26. Accordingly, the other valve is designed as an additional valve 22 in the form of a so-called LS pressure control valve which is supplied not by LS pressure in the LS control line, but by the pressure of the pressure supply source P and in the spring space of the section compensator 26 produces an artificial load pressure which can be varied from a value of zero to Pmax. Regardless of the actual load pressure, this pressure difference can be electrically set almost at will. In this way precision control at a low pressure difference and maximum pump quantity over the section is possible at the maximum pressure difference. The load pressure is measured by way of a pressure sensor 36 which relays the pressure value to a microprocessor or microcontroller MC as a component of the valve electronics which are not detailed. The valve electronics then control the low actuating pressure after stipulating an external setpoint and at the same time correct the higher actuating pressure by zero point correction of the lower actuating pressure.

Another advantageous use of this solutions consists in providing a control unit of a certain nominal width which is not shown, in which only a single consumer connection (A, B) requires a larger nominal width. Then, for reasons of saving costs the smaller control block can be retained because the necessarily large amount can be achieved by way of a high pressure difference on the metering diaphragm, formed by the input side of the valve slide 12 (input of the supply line 28).

1. A valve arrangement with an adjustable directional control valve (10) with a control slide (12) for actuating at least one consumer connection (A, B) and with an LS control line, the pressure difference of two actuating pressures (xₐ, x_{b}) being used to actuate the control slide (12), characterized in that the actuating pressures (xₐ, x_{b}) additionally actuate a logic valve (20) which in turn acts on an additional valve (22) and/or a compensator (26) which is connected upstream from the directional control valve (10) to the control slide (12).

2. The valve arrangement according to claim 1, characterized in that the logic valve (20) is designed as a selector valve or a selector valve which acts in an inverted manner.

3. The valve arrangement according to claim 1, characterized in that the additional valve (22) is a pilot-controlled check valve or a pressure limitation valve (DBV) which can be actuated by means of a pressure intensification stage (24) which acquires its input pressure from the output side of the logic valve (20).

4. The valve arrangement according to claim 1, characterized in that the compensator (26) is connected between a pressure supply (P) and the input side (metering diaphragm) of the directional control valve (10).

5. The valve arrangement according to claim 4, characterized in that the other actuating pressure which operates oppositely to the actuating pressure of the additional valve (22) acts on the compensator (26) and originates from the fluid-carrying connection (supply line 28) between the compensator (26) and the directional control valve (10) or additionally in throttled form (throttle 38) takes into account the control pressure of the additional valve (22).

6. The valve arrangement according to claim 1, characterized in that the LS control line is connected by way of a pressure sensor (36) to a microprocessor (MC) of the valve control electronics.

7. The valve arrangement according to claim 1, characterized in that the actuating pressures (xₐ, x_{b}) are dictated by one separately acting pilot valve (14, 16) at a time.

8. The valve arrangement according to claim 6, characterized in that the microprocessor (MC) of the valve control electronics actuates the two pilot valves (14, 16).

9. The valve arrangement according to claim 1, characterized in that the LS control line provided with a diaphragm or throttle (18) is connected to the additional valve (22).

10. The valve arrangement according to claim 1, characterized in that the adjustable directional control valve (10) has at least one tank connection (T).
